(19) United States
(12) Patent Application Publication
(10) Pub. No.: US 2007/0252536 A1
(43) Pub. Date: Nov. 1, 2007

(54) DISPLAY WITH ILLUMINATOR LAMP

(75) Inventor: Ming-Chun Wang, Yung Ho City (TW)

Correspondence Address: PAI PATENT & TRADEMARK LAW FIRM, 1001 FOURTH AVENUE, SUITE 3200, SEATTLE, WA, 98154, US

(73) Assignee: PROVIEW ELECTRONICS CO., LTD., Yung Ho City (TW)

(21) Appl. No.: 11/308,766

(22) Filed: Apr. 29, 2006

(51) Int. Cl. H05B 39/00

(52) U.S. Cl. 315/312

(57) ABSTRACT

A display with illuminator lamp includes a case, a display control circuit, a control unit, a display unit, and an illuminator lamp. The display is electrically connected to a personal computer; and the illuminator lamp includes three R, G, B LED lamps, an adjusting resistance, and a controlled switch assembly. The controlled switch assembly is used to receive control signals from the control unit, and control the on/off state of the illuminator lamp. The controlled switch assembly may be a switching transistor or a MOSFET. The illuminator lamp further includes three limiting resistances separately connected to the RGB LED lamps in series. With these arrangements, the display with illuminator lamp functions to illuminate a specific area before the display, so that a user may operate a keyboard or read documents in a dark environment.

### FIELD OF THE INVENTION

The present invention relates to a display, and more particularly, to a display with an illuminator lamp.

### BACKGROUND OF THE INVENTION

A conventional display typically includes a case, a display control circuit, a control unit, and a display unit. The case is normally provided on a front frame thereof with a plurality of function keys, one or more of which include a light-emitting diode (LED) lamp, such as the LED lamp on a POWER key. However, such LED lamps are designed to serve as indicator lamps, which are green in normal conditions and red in an abnormal conditions. Such LED lamps have limited brightness and could not be used as illuminator lamps. There are times the display is used in a dark environment and light is needed to illuminate the keyboard or documents positioned in front of the display. However, light from the display itself is not sufficient for this purpose.

### SUMMARY OF THE INVENTION

It is therefore a primary objective of the present invention to provide a display with an LED illuminator lamp provided thereon, so as to solve the problem of using the display and operating a keyboard in a dark environment.

To achieve the above and other objectives, the display according to the present invention includes a case, a display control circuit, a control unit, and a display unit. The display is electrically connected to a personal computer (PC), and also includes an illuminator lamp.

The illuminator lamp provided on the display of the present invention includes three LED lamps, namely, red (R), green (G), and blue (B) LED lamps, an adjusting resistance, and a controlled switch assembly. The controlled switch assembly receives control signals from the control unit, and controls the on or off status of the illuminator lamp.

The controlled switch assembly may be a switching transistor or a MOSFET (Metal-Oxide-Semiconductor FET).

The illuminator lamp may include three limiting resistances separately connected to the R, G, B LED lamps in series.

The illuminator lamp may further include one, two, or three regulating resistances, which are separately connected to the limiting resistances in parallel, and separately connected electrically to the control unit.

When the controlled switch assembly is in an off state, the regulating resistances may regulate the brightness of at least one of the three RGB LED lamps under the control of the control unit. And, when the controlled switch assembly is in an on state, the control unit may directly turn one or more of the three RGB lamps on or off, so as to change the color of the illuminator lamp.

The illuminator lamp may work in three different lighting modes:

a. Normal mode: When the display works normally, one of the LED lamps is turned on under the control of the control unit, and the illuminator lamp functions like an indicator lamp and emits a monocolor of R, G, or B.

b. Energy-saving mode: When the display is in an energy-saving state, two of the three LED lamps are turned on under the control of the control unit, and the illuminator lamp functions like an indicator lamp and emits a mixed color.

c. High luminance mode: All three LED lamps are turned on under the control of the control unit, and the illuminator lamp is in high luminance mode and functions like an illuminator. The duration of the high luminance mode may also be controlled by the control unit. The illuminator lamp automatically returns to the normal mode after the high luminance mode terminates.

The high luminance mode of the illuminator lamp may also be activated via a keyboard or a mouse connected to the personal computer.

The illuminator lamp further includes a lighting switch, which may turn the illuminator lamp on or off via the control unit.

The illuminator lamp is located on a front frame of the case of the display.

The display with illuminator lamp according to the present invention may satisfactorily provide the function of illuminating a specific area in a dark environment, so as to fulfill the need of operating the keyboard or reading documents in front of the display in a dark environment.

### BRIEF DESCRIPTION OF THE DRAWINGS

The structure and the technical means adopted by the present invention to achieve the above and other objectives can be best be understood by referring to the following detailed description of the preferred embodiments and the accompanying drawings, wherein

FIG. 1 is a front view of a display with illuminator lamp according to the present invention;

FIG. 2 is a block diagram of the display with illuminator lamp according to the present invention; and

FIGS. 3A, 3B, 3C, 3D, and 3E are circuit diagrams of the display with illuminator lamp according to five different embodiments of the present invention.

### DETAILED DESCRIPTION OF THE PREFERRED EMBODIMENTS

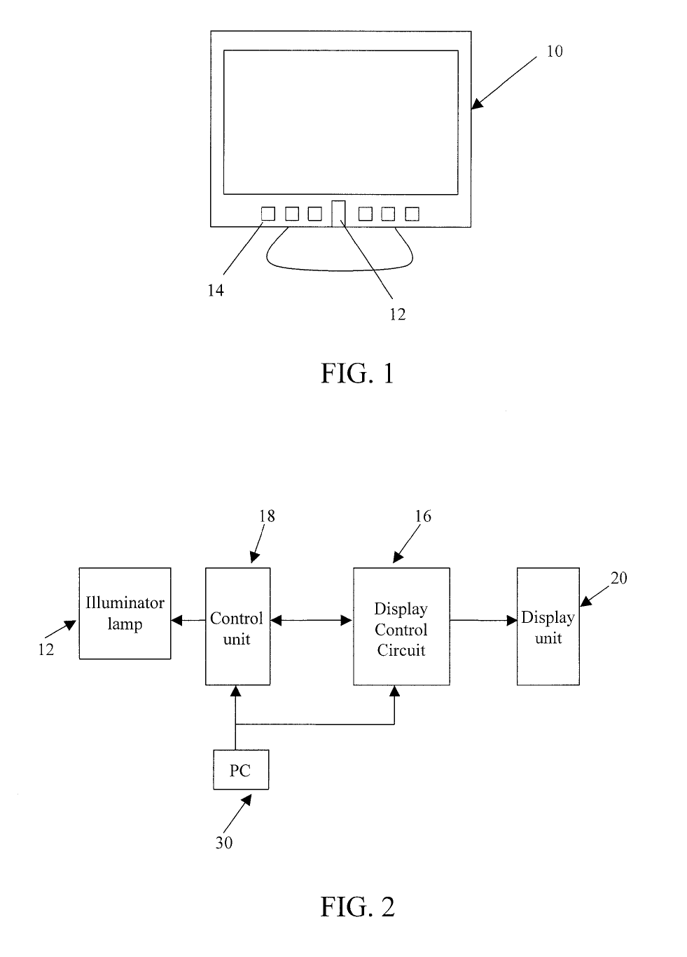

Please refer to FIG. 1 that is a front view of a display with illuminator lamp according to the present invention. As shown, a display 10, which may be a cathode-ray tube (CRT) display or a flat-panel display, is provided on a front frame of a case thereof with an LED illuminator lamp 12 and a lighting switch 14. The LED illuminator lamp 12 is able to illuminate a specific area, such as a keyboard, in front of the frame of the display 10. The lighting switch 14 is used to control the on/off state of the illuminator lamp 12.

As shown in FIG. 2, the display 10 includes an illuminator lamp 12, a control unit 18, a display control circuit 16, and a display unit 20. The display control circuit 16 and the control unit 18 are connected together and the connection facilitates two-way communication. The display control circuit 16 and the control unit 18 are also connected to a personal computer (PC) 30. The display control circuit 16 receives image signals from the PC 30 as well as control signals from the control unit 18, and processes the received signals before sending them to the display unit 20. The control unit 18 may receive a control signal from the PC 30 or the lighting switch 14 to control the on/off state of the illuminator lamp 12.

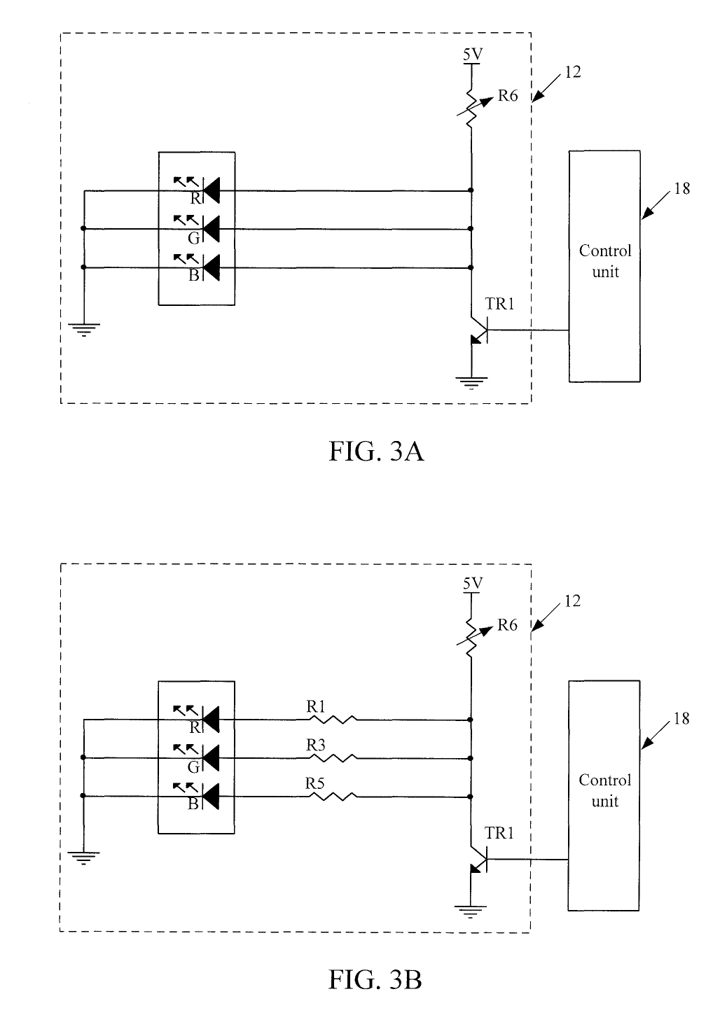

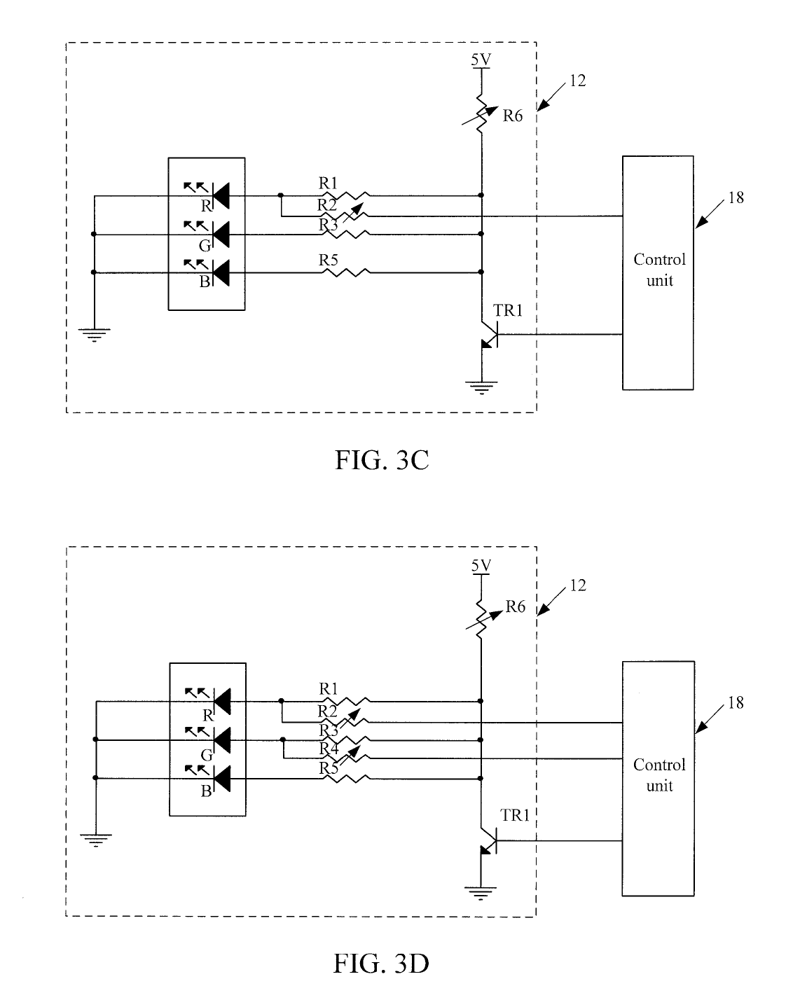

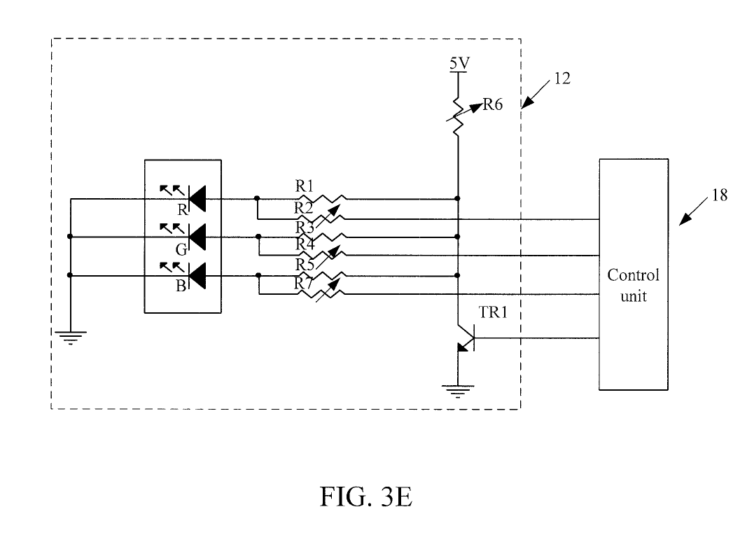

FIGS. 3A to 3E are circuit diagrams of the display with illuminator lamp according to five different embodiments of the present invention. In FIG. 3A, the illuminator lamp 12 includes three LED lamps, namely, a red (R), a green (G), and a blue (B) LED lamp; an adjusting resistance R6, and a controlled switch assembly TR1. The controlled switch assembly TR1 may be a switching transistor or a MOSFET (Metal-Oxide-Semiconductor FET). FIG. 3A shows the above-mentioned components of the display 10, and the connection between these components and the control unit 18. The adjusting resistance R6 has a resistance value that enables the illuminator lamp 12 to show different degrees of brightness. The controlled switch assembly TR1 may turn the illuminator lamp 12 on or off under the control of the control unit 18. The illuminator lamp 12 may further include three limiting resistances R1, R3, and R5 respectively connected to the R, G, and B LED lamps in series, as shown in FIG. 3B.

As shown in FIGS. 3C, 3D and 3E, the illuminator lamp 12 based on the circuit diagram and function of FIG. 3B may further include one, two or three regulating resistances R2, R4, and R7. The regulating resistances R2, R4, and R7 are respectively connected to the limiting resistances R1, R3, R5 in parallel, and are electrically connected to the control unit 18. When the controlled switch assembly TR1 is in an off state, the regulating resistances R2, R4, and R7 may regulate the brightness of at least one of the three RGB LED lamps under the control of the control unit 18. And, when the controlled switch assembly TR1 is in an on state, the control unit 18 may directly turn on one or more of the three RGB LED lamps on or off. Under this condition, the illuminating lamp 12 may serve as an indicator lamp.

The illuminating lamp 12 of the display 10 may work in three different lighting modes as follows:

a. Normal mode: When the display works normally, one of the LED lamps is turned on under the control of the control unit 18; and the illuminator lamp 12 functions like an indicator lamp and emits a monocolor of R, G, or B.

b. Energy-saving mode: When the display 10 is in an energy-saving state, two of the three LED lamps are turned on under the control of the control unit 18; and the illuminator lamp 12 functions like an indicator lamp and emits a mixed color, such as orange.

c. High luminance mode: All three LED lamps are turned on under the control of the control unit 18; and the illuminator lamp 12 is in a high luminance mode and functions like an illuminator. The duration of the high luminance mode may be controlled by the control unit 18. The illuminator lamp 12 automatically returns to the normal mode after the high luminance mode terminates.

The high luminance mode of the illuminator lamp 12 may be turned on/off with the lighting switch 14. In this case, when the lighting switch 14 is switched off, the illuminator lamp 12 returns from the high luminance mode to the normal mode. Alternatively, the high luminance mode of the illuminator lamp 12 may be activated by pushing any key on a keyboard or moving a mouse, both of which are connected to the personal computer 30. In this case, when a preset period of time lapses, the high luminance mode terminates and the illuminator lamp 12 is returned to the normal mode.

What is claimed is:

1. A display with illuminator lamp, comprising a case, a display control circuit, a control unit, and a display unit; said display being electrically connected to a personal computer, and characterized in an illuminator lamp provided on said display.

2. The display with illuminator lamp as claimed in claim 1, wherein said display is selected from the group consisting of CRT display and flat-panel display.

3. The display with illuminator lamp as claimed in claim 1, wherein said illuminator lamp includes three LED lamps showing at least one of the R, G, and B colors, an adjusting resistance, and a controlled switch assembly; and said controlled switch assembly is used to receive control signals from said control unit and control the on/off state of said illuminator lamp.

4. The display with illuminator lamp as claimed in claim 3, wherein said controlled switch assembly is selected from the group consisting of switching transistor and MOSFET.

5. The display with illuminator lamp as claimed in claim 3, wherein said illuminator lamp further includes limiting resistances separately connected to said LED lamps in series.

6. The display with illuminator lamp as claimed in claim 1, wherein said illuminator lamp includes three LED lamps, namely R, G, and B LED lamps; an adjusting resistance; limiting resistances separately connected to said LED lamps in series; and a controlled switch assembly; and said controlled switch assembly is used to receive control signals from said control unit and control the on/off state of said illuminator lamp.

7. The display with illuminator lamp as claimed in claim 6, wherein said controlled switch assembly is selected from the group consisting of switching transistor and MOSFET.

8. The display with illuminator lamp as claimed in claim 6, wherein said illuminator lamp further includes regulating resistances separately connected to said limiting resistances in parallel, and said regulating resistances being electrically connected to said control unit.

9. The display with illuminator lamp as claimed in claim 8, wherein said illuminator lamp is able to work in three different lighting modes:
a. Normal mode: When said display works normally, one of said LED lamps is turned on under the control of said control unit, and said illuminator lamp functions like an indicator lamp and emits a monocolor of R, G, or B;
b. Energy-saving mode: When said display is in an energy-saving state, two of said three LED lamps are turned on under the control of said control unit, and said illuminator lamp functions like an indicator lamp and emits a mixed color; and
c. High luminance mode: All said three LED lamps are turned on under the control of said control unit, and said illuminator lamp is in a high luminance mode and functions like an illuminator; and said high luminance mode has a duration controlled via said control unit, such that said illuminator lamp automatically returns to the normal mode after the high luminance mode terminates.

10. The display with illuminator lamp as claimed in claim 9, wherein said illuminator lamp is switched to the high luminance mode via a keyboard or a mouse connected to said personal computer.

11. The display with illuminator lamp as claimed in claim 1, wherein said display further includes a lighting switch, which is able to control the on/off state of said illuminator lamp via said control unit.

12. The display with illuminator lamp as claimed in claim 3, wherein said display further includes a lighting switch, which is able to control the on/off state of said illuminator lamp via said control unit.

13. The display with illuminator lamp as claimed in claim 5, wherein said display further includes a lighting switch, which is able to control the on/off state of said illuminator lamp via said control unit.

14. The display with illuminator lamp as claimed in claim 6, wherein said display further includes a lighting switch, which is able to control the on/off state of said illuminator lamp via said control unit.

15. The display with illuminator lamp as claimed in claim 8, wherein said display further includes a lighting switch, which is able to control the on/off state of said illuminator lamp via said control unit.

16. The display with illuminator lamp as claimed in claim 9, wherein said display further includes a lighting switch, which is able to control the on/off state of said illuminator lamp via said control unit.

17. The display with illuminator lamp as claimed in claim 10, wherein said display further includes a lighting switch, which is able to control the on/off state of said illuminator lamp via said control unit.

18. The display with illuminator lamp as claimed in claim 1, wherein said illuminator lamp is located on a front frame of the case of said display.
